(19) United States
(12) Patent Application Publication
(10) Pub. No.: US 2025/0234804 A1
(43) Pub. Date: Jul. 24, 2025

(54) Crop Measurement Accuracy Improvement System and Method

(71) Applicant: Deere & Company, Moline, IL (US)

(72) Inventors: Rana Shakti Singh, Ramgarh (IN); Nathan R. Vandike, Geneseo, IL (US)

(21) Appl. No.: 18/417,760

(22) Filed: Jan. 19, 2024

(51) Int. Cl. A01D 41/127; A01D 41/12; G01G 19/08

(52) U.S. Cl. CPC A01D 41/1275; A01D 41/1208; G01G 19/08

(57) ABSTRACT

A crop measurement system of an agricultural machine that harvests and processes crop includes a tank configured to store harvested crop and a crop conveyer configured to provide the harvested crop to the tank. The agricultural machine further includes a controller, at least one weight sensor, and at least one image sensor. The controller is configured to: receive weight measurements of only a portion of harvested crop in the tank from the at least one weight sensor, receive dimension and location measurements of the total amount of harvested crop in the tank from the at least one image sensor, and determine the mass of the total amount of harvested crop stored in the tank based on one or more signals received from the at least one weight sensor and one or more signals received from the at least one image sensor.

### FIELD OF THE DISCLOSURE

The present description relates to agricultural machines and, in particular, to harvested crop measurement systems of agricultural machines.

### BACKGROUND OF THE DISCLOSURE

There are a variety of different types of agricultural machines. Some agricultural machines include combine harvesters, sugar cane harvesters, cotton harvesters, self-propelled forage harvesters, and windrowers. During operation, agricultural machines may thresh, chop, or otherwise process harvested crop. The harvested crop is often provided to a tank. It is important to accurately quantify the amount of harvested crop.

### SUMMARY

In an illustrative implementation, a crop measurement system of an agricultural machine comprises: a tank configured to store harvested crop; a crop conveyer configured to provide the harvested crop to the tank; at least one weight sensor configured to measure the weight of a portion of the harvested crop stored in the tank, the portion being that which is positioned above the at least one weight sensor; at least one image sensor configured to capture one or more images indicative of the dimensions of the harvested crop stored in the tank and the location of the harvested crop stored in the tank; and a controller configured to: receive one or more signals from the at least one weight sensor indicative of the weight of the portion of the harvested crop measured by the at least one weight sensor; receive one or more signals from the at least one image sensor indicative of the dimensions of the harvested crop stored in the tank and the location of the harvested crop stored in the tank; and determine the mass of the harvested crop stored in the tank based on the one or more signals received from the at least one weight sensor and the one or more signals received from the at least one image sensor. In some implementations, the at least one image sensor is spaced apart from the harvested crop stored in the tank.

In some implementations, the controller is configured to determine the mass of the harvested crop stored in the tank further based on the location of the at least one weight sensor. In some implementations, the crop measurement system further comprises at least one tilt sensor configured to measure the tilt of the agricultural machine relative to the direction of gravity; the controller is configured to receive one or more signals from the at least one tilt sensor indicative of the tilt of the agricultural machine relative to the direction of gravity; and the controller is configured to determine the mass of the harvested crop stored in the tank further based on the one or more signals received from the at least one tilt sensor.

In some implementations, the controller is configured to determine the mass of a remaining portion of harvested crop stored in the tank based on the dimensions of the harvested crop stored in the tank, the location of the harvested crop stored in the tank relative to the location of the at least one weight sensor, and the one or more signals received from the at least one weight sensor. In such implementations, the remaining portion of harvested crop stored in the tank is the harvested crop stored in the tank excluding the portion of harvested crop measured by the at least one weight sensor.

In some implementations, the controller is configured to determine the dimensions of the portion of harvested crop stored in the tank and the dimensions of a remaining portion of harvested crop stored in the tank based on the location of the harvested crop stored in the tank relative to the location of the at least one weight sensor. In some implementations, the controller is configured to determine the mass of a remaining portion of harvested crop stored in the tank based on the dimensions of the portion of harvested crop stored in the tank, the dimensions of the remaining portion of harvested crop stored in the tank, and the one or more signals received from the at least one weight sensor. In some implementations, the controller is configured to determine the mass of the harvested crop stored in the tank based on the mass of the portion of harvested crop stored in the tank and the mass of the remaining portion of harvested crop stored in the tank.

In some implementations, the at least one weight sensor includes a first weight sensor and a second weight sensor; and the first weight sensor is located at a different height than the second weight sensor. In some implementations, the crop conveyer includes an outlet from which harvested crop is provided to the tank. In some implementations, the outlet of the crop conveyer is located at a greater height than the at least one weight sensor. In some implementations, the at least one image sensor includes at least one of a first sensor positioned on the crop conveyor at a greater height than the outlet of the crop conveyor and a second sensor positioned on the crop conveyor at a lesser height than the outlet of the crop conveyor.

In some implementations, the controller is configured to receive a yield measurement of the harvested crop; the controller is configured to determine an adjusted yield value of the harvested crop based on the mass of the harvested crop stored in the tank; and the controller is configured to determine a yield calibration value for a yield calibration curve based on the yield measurement and the adjusted yield value.

In some implementations, the controller is configured to: receive an additional yield measurement; determine a yield output that is different from the additional yield measurement based on the additional yield measurement and the yield calibration curve; and provide the yield output to a user display. In some implementations, the controller is configured to adjust a harvesting plan for the agricultural machine based on the yield calibration curve. In some implementations, the controller is configured to adjust a harvesting plan for the agricultural machine based on the mass of the harvested crop stored in the tank.

In some implementations, the crop measurement system further comprises: a threshing assembly configured to process the harvested crop; and the crop conveyer is configured to provide harvested crop processed by the threshing assembly to the tank.

In another illustrative implementation, a crop measurement system of an agricultural machine comprises: a tank configured to store harvested crop; a crop conveyer configured to provide the harvested crop to the tank; at least one weight sensor configured to measure the weight of a portion of the harvested crop stored in the tank; a controller configured to: receive one or more signals from the at least one weight sensor indicative of the weight of the portion of the harvested crop stored in the tank; receive one or more signals from at least one image sensor indicative of the dimensions of the harvested crop stored in the tank and the location of the harvested crop stored in the tank; and determine the mass of the harvested crop stored in the tank based on the one or more signals received from the at least one weight sensor and the one or more signals received from the at least one image sensor.

In some implementations, the controller is configured to receive a yield measurement of the harvested crop from a yield measurement sensor of the agricultural machine; the controller is configured to determine an adjusted yield value of the harvested crop based on the mass of the harvested crop stored in the tank; and the controller is configured to determine a calibration value for a yield calibration curve based on the yield measurement relative to the adjusted yield value.

In some implementations, the controller is configured to: receive an additional yield measurement; determine a yield output that is different from the additional yield measurement based on the additional yield measurement and the yield calibration curve; and provide the yield output to a user display.

In another illustrative implementation, a method of measuring harvested crop for an agricultural machine comprises: receiving one or more signals from at least one weight sensor that is located in a tank of the agricultural machine, the tank being configured to store harvested crop and the one or more signals being indicative of the weight of a portion of the harvested crop stored in the tank; receiving one or more signals from at least one additional sensor indicative of the dimensions of the harvested crop stored in the tank and the location of the harvested crop stored in the tank; and determining the mass of the harvested crop stored in the tank based on the one or more signals received from the at least one weight sensor and the one or more signals received from the at least one additional sensor.

In some implementations, the method further comprises: determining the mass of a remaining portion of harvested crop stored in the tank based on the dimensions of the harvested crop stored in the tank, the location of the harvested crop stored in the tank, the location of the at least one weight sensor, and the weight of the portion of the harvested crop measured by the at least one weight sensor; and determining the mass of the harvested crop stored in the tank based on the mass of the portion of harvested crop stored in the tank and the mass of the remaining portion of harvested crop stored in the tank.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of an example agricultural machine configured to harvest and process crop;

FIG. 2A is top-down view of an exemplary tank of the agricultural machine;

FIG. 2B is a diagrammatic view of an exemplary tank of the agricultural machine in a tilted orientation with harvested crop in the tank;

FIG. 3 is a diagrammatic view of an exemplary control system for the agricultural machine;

FIG. 4 is a flow diagram of an example method of measuring harvested crop for an agricultural machine;

FIG. 5 is a flow diagram showing a block of the example method shown in FIG. 4 in more detail; and

FIG. 6 is a calibration curve configured to be generated and used in accordance with the example method of FIGS. 4 and 5.

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

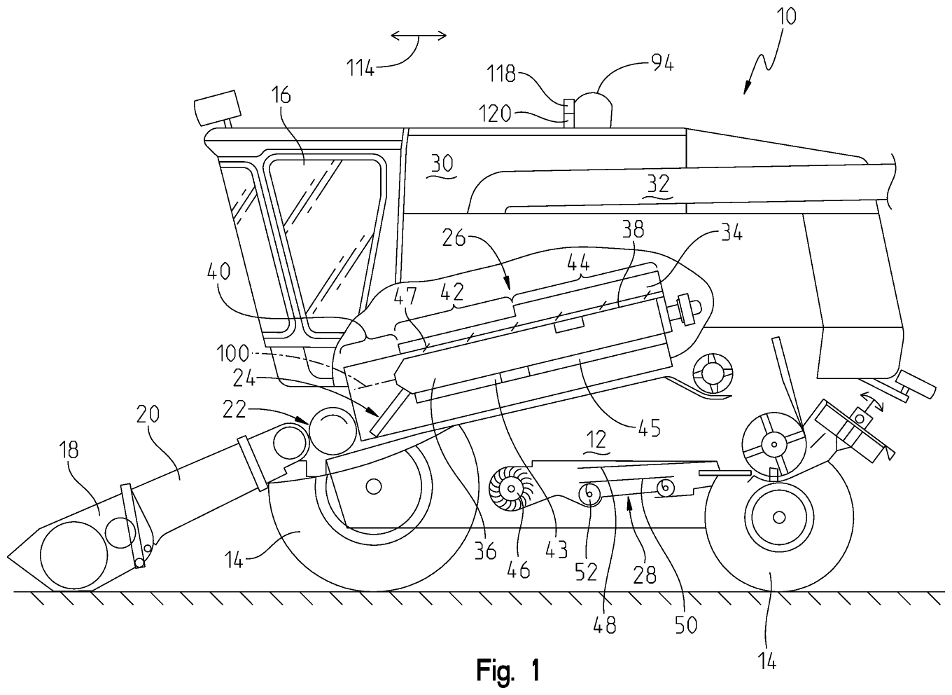

In FIG. 1, an implementation of an agricultural machine 10 is shown. The agricultural machine 10 includes a frame 12 and one or more ground engaging mechanism, such as wheels 14 or tracks, that are in contact with an underlying ground surface. In the illustrative implementation, the wheels 14 are coupled to the frame 12 and are used for movement of the agricultural machine 10 in a forward operating direction (which is to the left in FIG. 1) and in other directions. The agricultural machine 10 includes a prime mover, such as an engine, for propulsion of the agricultural machine 10. In some implementations, operation of the agricultural machine 10 is controlled from an operator's cab 16. The operator's cab 16 may include any number of controls for controlling operation of the agricultural machine 10, such as a user interface 212. In some implementations, operation of the agricultural machine 10 is conducted by a human operator in the operator's cab 16, a remote human operator, or an automated system.

A cutting head 18 is disposed at a forward end of the agricultural machine 10 and is used to harvest crop and to conduct harvested crop to a slope conveyor 20. The term harvested crop as used herein includes grain (e.g., corn, wheat, soybeans, rice, oats) and material other than grain (MOG). The slope conveyor 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors. A single threshing rotor 36 is shown in FIG. 1. The threshing rotor 36 includes a drum 38 arranged along a threshing axis 100, and the threshing rotor 36 rotates about the threshing axis 100. The threshing assembly 26 further includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44. The threshing assembly 26 further includes a thresher basket 43 that is positioned in the threshing section 42 and below the threshing rotor 36, guide vanes 47 that are positioned above the threshing rotor 36, and a separating grate 45 that is positioned in the separating section 44 and below the threshing rotor 36. Harvested crop falls through the thresher basket 43 and through the separating grate 45.

In some implementations, the harvested crop is directed to a clean crop routing assembly 28 with a blower 46 and sieves 48, 50 with louvers. The sieves 48, 50 can be oscillated in a fore-and-aft direction indicated by the arrow 114. The clean crop routing assembly 28 removes MOG and guides grain over a screw conveyor 52 to a crop conveyer 94. In some implementations, the crop conveyer 94 elevates the harvested crop and deposits the harvested crop in a tank 30, as shown in FIG. 1. The harvested crop in the tank 30 can be unloaded off the agricultural machine by means of an unloading screw conveyor 32, for example, to a grain wagon, trailer, truck or other receiving unit.

As shown in FIG. 1, in the illustrative implementation, the agricultural machine 10 includes at least one sensor 118 that is, for example, positioned on the crop conveyer 94 and configured to measure a yield of the harvested crop. The at least one sensor 118 is configured to measure a force of harvested crop urged into contact with the at least one sensor 118 before the harvested crop is deposited into the tank 30. In some implementations, the agricultural machine 10 includes at least one sensor 120 that is, for example, positioned in a path of the harvested crop and configured to measure a moisture level of the harvested crop.

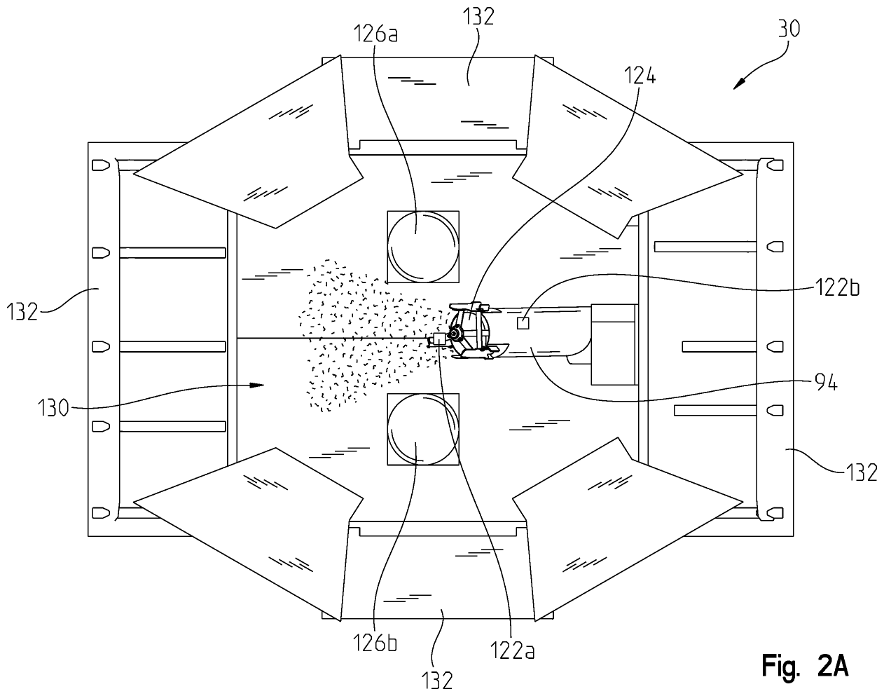

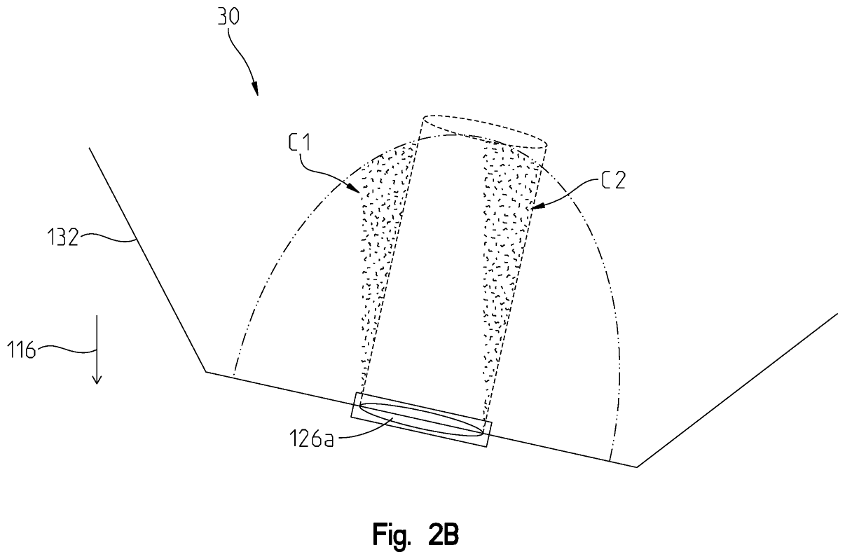

In some implementations, as shown in FIG. 2A, the tank 30 includes a floor 130 and a plurality of side walls 132 surrounding and extending upward from the floor 130. The tank 30 includes additional portions coupled between the side walls 132, which, in some implementations, accommodate movement of the side walls relative to the floor 130. In some implementations, the floor 130 comprises a plurality of sections, where different sections of the floor 130 are arranged at different heights, angles, or both. The crop conveyor 94 transports harvested crop to the floor 130 of the tank 30, where the harvested crop builds on itself to form a pile, which is shown in FIG. 2A. Conventional agricultural machines may assume that a pile of harvested crop has a predetermined shape.

The agricultural machine 10 includes at least one sensor 122 configured to measure or capture one or more images indicative of the dimensions (e.g., size and shape) of the pile of harvested crop in the tank 30. The at least one sensor 122 is also configured to measure or capture one or more images indicative of the location of the pile of harvested crop stored in the tank 30. In various implementations, the at least one sensor 122 may be a camera, radar, or light emitting sensor (e.g., ultraviolet light sensor, LIDAR sensor). In the illustrative implementation, as shown in FIG. 2A, the at least one sensor 122 includes and first sensor 122a and a second sensor 122b.

In the illustrative implementation, the at least one sensor 122 is positioned on the crop conveyor 94; however, it should be appreciated that in other implementations, one or more sensors of the at least one sensor 122 may be positioned away from the crop conveyor 94, e.g., on the plurality of side walls 132 of the tank 30. In various implementations, the crop conveyor 94 may be a screw conveyor, as shown in FIG. 2A, a belt conveyor, or any other conveyer for transporting harvested crop to the tank 30. In the illustrative implementation, the crop conveyor 94 includes an outlet 124 from which the harvested crop exits the crop conveyor 94 as it is distributed to the tank 30. In some implementations, the at least one sensor 122 is positioned at a greater height than the outlet 124 of the crop conveyor 94. In some implementations, the at least one sensor 122 is positioned at a lesser height than the outlet 124 of the crop conveyor 94. In some implementations, the first sensor 122a is positioned at a greater height than the outlet 124 of the crop conveyor 94 and the second sensor 122b is positioned at a lesser height than the outlet 124 of the crop conveyor 94. In the illustrative implementation, the at least one sensor 122 is spaced apart from the pile harvested crop in the tank 30. The pile of harvested crop may be referred to as the total amount of harvested crop in the tank 30.

In the illustrative implementation, the agricultural machine 10 includes at least one sensor 126 configured to measure the weight of a portion of the harvested crop stored in the tank 30. The portion of harvested crop measured by the at least one sensor 126 is that which is positioned above the at least one sensor 126. In the illustrative implementation, the at least one sensor 126 is a scale. In the illustrative implementation, the at least one sensor 126 includes a circular top surface; however, it should be appreciated that in other implementations, the top surface may be rectangular, oval-shaped, or any other shape.

In the illustrative implementation, the agricultural machine 10 includes at least one sensor 150 configured to measure a tilt of the agricultural machine 10 relative to the direction of gravity 116. It should be appreciated that the portion of harvested crop measured by the at least one sensor 126 (i.e. that which is located above the at least one sensor 126) may change as the agricultural machine 10 tilts. For example, as shown in FIG. 2B, in implementations in which the at least one sensor 126 includes a circular top surface, where the agricultural machine 10 is tilted such that the circular top surface is not perpendicular to the direction of gravity (i.e., arrow 116), the portion of harvested crop measured by the at least one sensor 126: (i) includes certain harvested crop (C1) located outside an imaginary circular cylindrical column extending perpendicularly away from the circumference of the circular top surface, and (ii) excludes certain harvested crop (C2) located inside the imaginary circular cylindrical column. In such an example (where the agricultural machine 10 is tilted), the portion of harvested crop measured by the at least one sensor 126 has an elliptical (rather than circular) cross section. This aspect of the disclosure is applicable to implementations in which the top surface of the at least one sensor 126 is circular or any other shape.

In various implementations, the at least one sensor 126 may be embodied as a strain gauge, capacitance sensor, hydraulic sensor, pneumatic sensor, or any other weight sensor. In the illustrative implementation, the at least one sensor 126 is positioned on the floor 130 of the tank 30; however, it should be appreciated that in other implementations, one or more of the at least one sensors 126 may be positioned on the plurality of side walls 132 or otherwise above the floor 130 of the tank 30. In the illustrative implementation, as shown in FIG. 2A, the at least one sensor 122 includes a first sensor 126a positioned on a first section of the floor 130 and a second sensor 126b positioned on a second section of the floor 130.

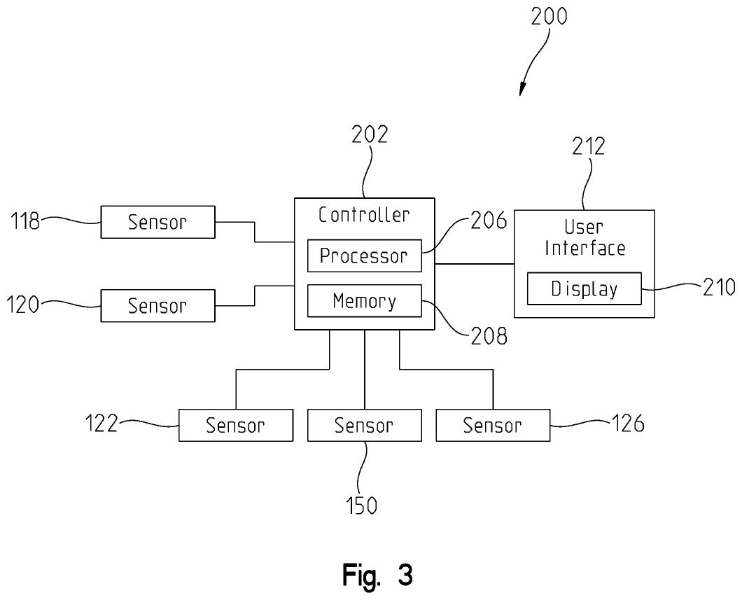

Referring now to FIG. 3, an exemplary control system 200, which includes a controller 202, is shown. The control system 200 includes one or more memories 206 that are included in or accessible by the controller 202 and one or more processors 208 that are included in or accessible by the controller 202. The one or more processors 208 are configured to execute instructions (e.g., one or more algorithms) stored on the one or more memories 206. The controller 202 may be a single controller or a plurality of controllers operatively coupled to one another. The controller 202 may be positioned on the agricultural machine 10 or positioned remotely, away from the agricultural machine 10. The controller 202 may be coupled via a wired connection or wirelessly to other components of the agricultural machine 10 and to one or more remote devices. In some instances, the controller 202 may be connected wirelessly via Wi-Fi, Bluetooth, Near Field Communication, or another wireless communication protocol to other components of the agricultural machine 10 and to one or more remote devices.

As shown in FIG. 3, the controller 202 is operatively coupled to each of sensors 118, 120, 122, 126, and 150 and configured to receive one or more signals therefrom. For example, the controller 202 is configured to receive one or more signals from the at least one sensor 126 indicative of the weight of the portion of the harvested crop measured by the at least one sensor 126. The controller 202 is configured to receive one or more signals from the at least one sensor 122 indicative of: (i) the dimensions of the pile of harvested crop stored in the tank 30 and (ii) the location of the pile of harvested crop stored in the tank 30. The controller is configured to receive one or more signals from the at least one sensor 150 indicative of the tilt of the agricultural machine relative to the direction of gravity 116. As shown in FIG. 3, in the illustrative implementation, the controller 202 is operatively coupled to a display 210 and configured to output one or more signals to the display 210, such signals being described in more detail herein. In the illustrative implementation, the controller 202 is operatively coupled to a user interface 212 and configured to receive one or more signals from the user interface 212 such as those associated with a harvesting plan (e.g., speed, direction, cutting head height).

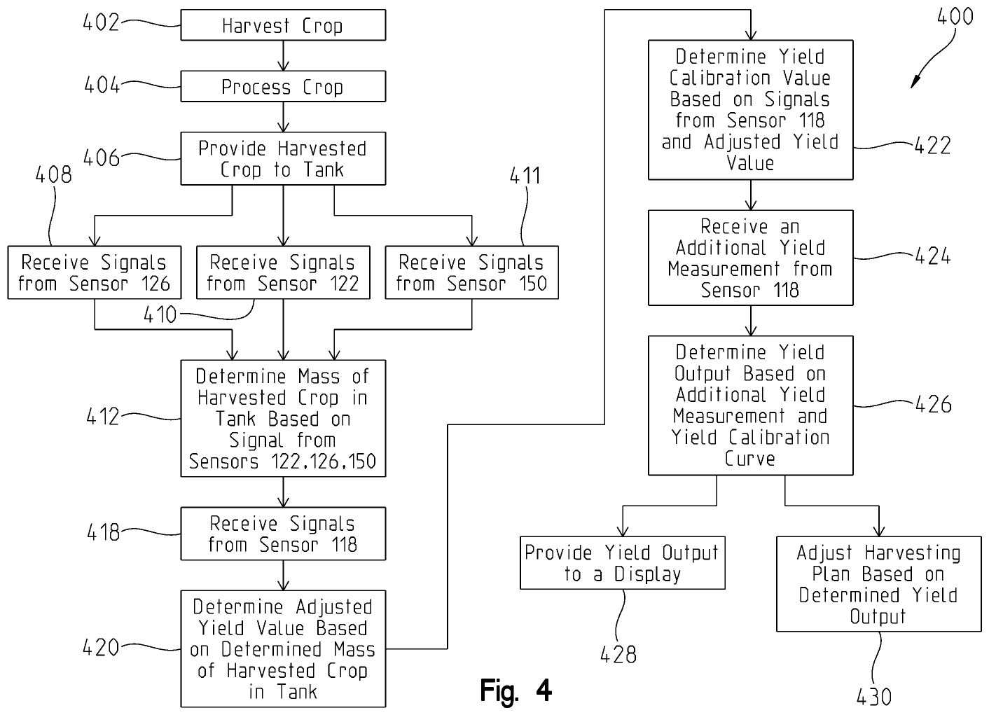

The control system 200 is usable to determine the mass of the harvested crop stored in the tank 30 in an example method 400, which is shown in FIG. 4. In the example method 400, in some implementations thereof, at a block 402, the agricultural machine 10 moves through a worksite to harvest crop. In some implementations, at a block 404, harvested crop is processed by one or more subsystems of the agricultural machine 10, including at least the threshing assembly 26. In some implementations, at block 406, the crop conveyer 94 provides harvested crop processed by the threshing assembly 26 to the tank 30.

Referring still to the method 400, at block 408, the controller 202 receives one or more signals from the at least one sensor 126 indicative of the weight of the portion of the harvested crop measured by the at least one sensor 126. At block 410, the controller 202 receives one or more signals from the at least one sensor 122 indicative of the dimensions of the pile of harvested crop stored in the tank 30 and the location of the pile of harvested crop stored in the tank 30. In some implementations, at block 411, the controller 202 receives one or more signals from the at least one sensor 150 indicative of the tilt of the agricultural machine 10 relative to the direction of gravity 116. At block 412, the controller 202 determines the mass of the pile of harvested crop stored in the tank 30 based on the one or more signals received from the at least one sensor 126 and the one or more signals received from the at least one sensor 122.

In some implementations, the controller 202 determines the mass of the pile of harvested crop stored in the tank 30 further based on the one or more signals received from the at least one sensor 150. For example, where the agricultural machine 10 is tilted such that the top surface of the at least one sensor 126 is not perpendicular to the direction of gravity 116, a weight measurement by the at least one sensor 126 accounts only a fraction of the mass of the portion of harvested crop above the at least one sensor 126. To account for such phenomenon, the controller 202 is configured to determine the mass of the portion of harvested crop by adjusting the weight of the portion of the harvested crop (which is measured by the at least one sensor 126) in view of the tilt of the agricultural machine 10 relative to the direction of gravity 116 (which is measured by the at least one sensor 150).

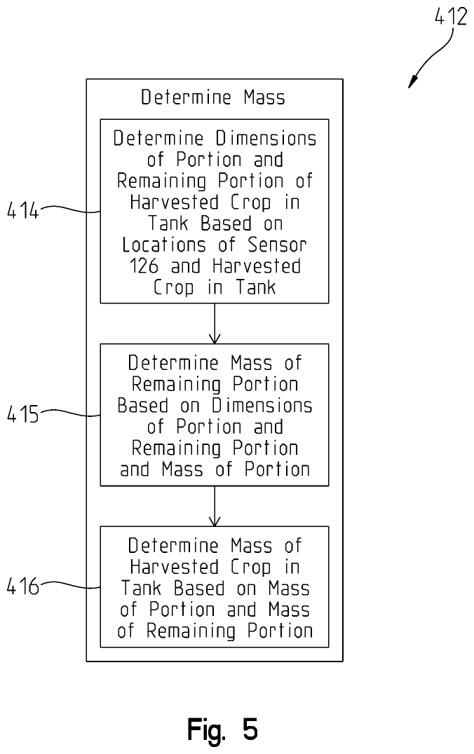

In the illustrative implementation, the controller 202 determines the mass of the harvested crop stored in the tank 30 further based on the location of the at least one sensor 126. For example, as shown in FIG. 5, at a block 414, (illustratively included in the block 412), the controller 202 utilizes the location of the at least one sensor 126 relative to the location and dimensions of the pile of harvested crop to determine: (i) the dimensions of the portion of harvested crop stored in the tank and (ii) the dimensions of a remaining portion of harvested crop that is stored in the tank 30. It should be appreciated that the remaining portion of harvested crop stored in the tank 30 is defined herein as the total amount of harvested crop stored in the tank 30 less the portion of harvested crop measured by the at least one sensor 126.

Referring still to FIG. 5, at a block 415, (illustratively included in the block 412), the controller 202 determines the mass of the remaining portion of harvested crop stored in the tank 30 based on the determined dimensions of the portion of harvested crop stored in the tank 30, the determined dimensions of the remaining portion of harvested crop stored in the tank 30, and the one or more signals received from the at least one sensor 126 indicating the weight of the portion of harvested crop stored in the tank 30. For example, with the dimensions of the remaining portion of harvested crop determined, the controller 202 utilizes the ratio of mass per dimensions of the portion of harvested crop to determine the mass of remaining portion of harvested crop.

At block 416, (illustratively included in the block 412), the controller 202 determines the mass of the total amount of harvested crop stored in the tank 30 based on the mass of the portion of harvested crop stored in the tank 30 and the mass of the remaining portion of harvested crop stored in the tank.

Referring still to method 400 as shown in FIG. 4, in some implementations, at a block 418, which is executed subsequent to the block 412, the controller 202 receives one or more signals from the at least one sensor 118 indicative of a yield measurement of the harvested crop taken by the at least one sensor 118. Referring still to method 400, as shown in FIG. 4, at a block 420, the controller 202 determines an adjusted yield value of the harvested crop based on the determined mass of the harvested crop stored in the tank 30. It should be appreciated that the yield measurement and adjusted yield value are quantifications approximating an amount of crop per unit area harvested by the agricultural machine 10 or per time.

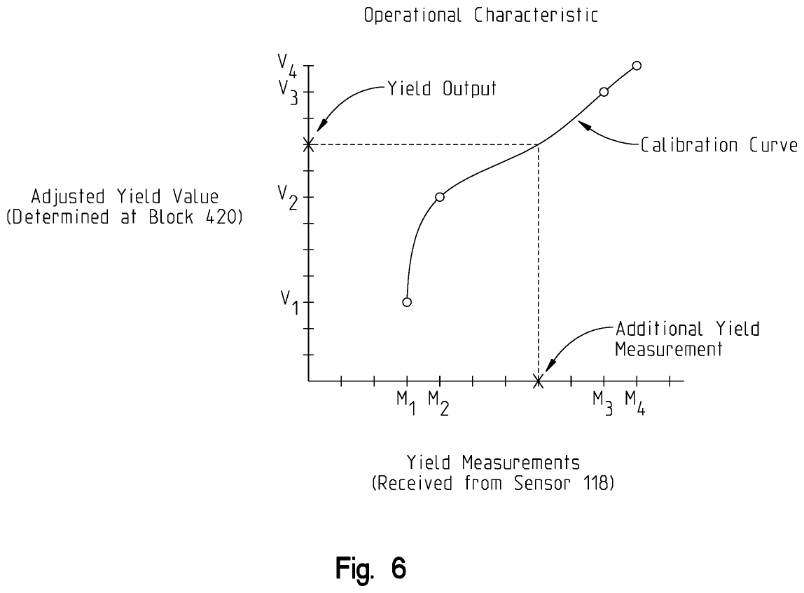

In the illustrative implementation, at a block 422, the controller 202 determines a yield calibration value based on the yield measurement and the adjusted yield value. For example, the yield calibration value is the point on a graph, such as that shown in FIG. 6, where the yield measurement and the adjusted yield value intersect. In the illustrative implementation, the controller 202 updates one or more yield calibration curves, each comprised of a plurality of yield calibration values for an operational characteristic of the agricultural machine 10 or the worksite (e.g., speed, crop type, moisture level), with the determined yield calibration value. An exemplary yield calibration curve is shown in FIG. 6. For the exemplary yield calibration curve of FIG. 6, the adjusted yield value was determined (as described by block 420) four times for a certain operational characteristic and plotted each time against the corresponding yield measurement received from the at least one sensor 118.

Referring again to the method 400 as shown in FIG. 4, in the illustrative implementation, at a block 424, the controller 202 receives an additional yield measurement, for example, from the at least one sensor 118. At a block 426, the controller 202 determines a yield output based on the additional yield measurement and the yield calibration curve. For example, as suggested by FIG. 6, the controller 202 determines the yield output by identifying the adjusted yield value at the point on the calibration curve intersected by the additional yield measurement.

In some implementations, at a block 428, the controller 202 provides the yield output to a display 210, which displays the yield output to a user, for example, in the cab 16 of the agricultural machine 10. In some implementations, at a block 430, the controller 202 adjusts the harvesting plan (e.g., speed, direction, cutting head height) for the agricultural machine 10 based on the determined mass of the harvested crop stored in the tank 30. For example, the controller 202 may adjust the harvesting plan automatically based on the determined mass of the harvested crop stored in the tank 30, automatically based on the yield calibration curve or yield output value, or based on one or more signals received from the user interface 212 (e.g., where such signals are indicative of user input received via the user interface 212 as result of the yield output displayed to the user via the display 210).

While the disclosure has been illustrated and described in detail in the drawings and foregoing description, such illustration and description is to be considered as exemplary and not restrictive in character, it being understood that illustrative implementation(s) have been shown and described and that all changes and modifications that come within the spirit of the disclosure are desired to be protected. It will be noted that alternative implementations of the present disclosure may not include all of the features described yet still benefit from at least some of the advantages of such features. Those of ordinary skill in the art may readily devise their own implementations that incorporate one or more of the features of the present disclosure and fall within the spirit and scope of the present disclosure as defined by the claims herein.

1. A crop measurement system of an agricultural machine, comprising:
a tank configured to store harvested crop;
a crop conveyer configured to provide the harvested crop to the tank;
at least one weight sensor configured to measure the weight of a portion of the harvested crop stored in the tank, the portion being that which is positioned above the at least one weight sensor;
at least one image sensor configured to capture one or more images indicative of the dimensions of the harvested crop stored in the tank and the location of the harvested crop stored in the tank; and
a controller configured to:
receive one or more signals from the at least one weight sensor indicative of the weight of the portion of the harvested crop measured by the at least one weight sensor;
receive one or more signals from the at least one image sensor indicative of the dimensions of the harvested crop stored in the tank and the location of the harvested crop stored in the tank; and
determine the mass of the harvested crop stored in the tank based on the one or more signals received from the at least one weight sensor and the one or more signals received from the at least one image sensor.

2. The crop measurement system of claim 1, wherein the controller is configured to determine the mass of the harvested crop stored in the tank further based on the location of the at least one weight sensor.

3. The crop measurement system of claim 1, further comprising at least one tilt sensor configured to measure the tilt of the agricultural machine relative to the direction of gravity;
wherein the controller is configured to receive one or more signals from the at least one tilt sensor indicative of the tilt of the agricultural machine relative to the direction of gravity and determine the mass of the harvested crop stored in the tank further based on the one or more signals received from the at least one tilt sensor.

4. The crop measurement system of claim 1, wherein the controller is configured to determine the mass of a remaining portion of harvested crop stored in the tank based on the dimensions of the harvested crop stored in the tank, the location of the harvested crop stored in the tank relative to the location of the at least one weight sensor, and the one or more signals received from the at least one weight sensor; and
wherein the remaining portion of harvested crop stored in the tank is the harvested crop stored in the tank excluding the portion of harvested crop measured by the at least one weight sensor.

5. The crop measurement system of claim 1, wherein the controller is configured to determine the dimensions of the portion of harvested crop stored in the tank and the dimensions of a remaining portion of harvested crop stored in the tank based on the location of the harvested crop stored in the tank relative to the location of the at least one weight sensor; and
wherein the remaining portion of harvested crop stored in the tank is the harvested crop stored in the tank excluding the portion of harvested crop measured by the at least one weight sensor.

6. The crop measurement system of claim 5, wherein the controller is configured to determine the mass of a remaining portion of harvested crop stored in the tank based on the dimensions of the portion of harvested crop stored in the tank, the dimensions of the remaining portion of harvested crop stored in the tank, and the one or more signals received from the at least one weight sensor.

7. The crop measurement system of claim 6, wherein the controller is configured to determine the mass of the harvested crop stored in the tank based on the mass of the portion of harvested crop stored in the tank and the mass of the remaining portion of harvested crop stored in the tank.

8. The crop measurement system of claim 1, wherein the at least one weight sensor includes a first weight sensor and a second weight sensor; and
wherein the first weight sensor is located at a different height than the second weight sensor.

9. The crop measurement system of claim 1, wherein the crop conveyer includes an outlet from which harvested crop is provided to the tank; and
wherein the outlet of the crop conveyer is located at a greater height than the at least one weight sensor.

10. The crop measurement system of claim 9, wherein the at least one image sensor includes at least one of a first image sensor positioned on the crop conveyor at a greater height than the outlet of the crop conveyor and a second image sensor positioned on the crop conveyor at a lesser height than the outlet of the crop conveyor.

11. The crop measurement system of claim 1, wherein the controller is configured to receive a yield measurement of the harvested crop;
wherein the controller is configured to determine an adjusted yield value of the harvested crop based on the mass of the harvested crop stored in the tank; and
wherein the controller is configured to determine a yield calibration value for a yield calibration curve based on the yield measurement and the adjusted yield value.

12. The crop measurement system of claim 11, wherein the controller is configured to:
receive an additional yield measurement;
determine a yield output that is different from the additional yield measurement based on the additional yield measurement and the yield calibration curve; and
provide the yield output to a user display.

13. The crop measurement system of claim 11, wherein the controller is configured to adjust a harvesting plan for the agricultural machine based on the yield calibration curve.

14. The crop measurement system of claim 1, wherein the controller is configured to adjust a harvesting plan for the agricultural machine based on the mass of the harvested crop stored in the tank.

15. The crop measurement system of claim 1, further comprising a threshing assembly configured to process the harvested crop; and
wherein the crop conveyer is configured to provide harvested crop processed by the threshing assembly to the tank.

16. A crop measurement system of an agricultural machine, comprising:
a tank configured to store harvested crop;
a crop conveyer configured to provide the harvested crop to the tank;
at least one weight sensor configured to measure the weight of a portion of the harvested crop stored in the tank;
a controller configured to:
receive one or more signals from the at least one weight sensor indicative of the weight of the portion of the harvested crop stored in the tank;
receive one or more signals from at least one image sensor indicative of the dimensions of the harvested crop stored in the tank and the location of the harvested crop stored in the tank; and
determine the mass of the harvested crop stored in the tank based on the one or more signals received from the at least one weight sensor and the one or more signals received from the at least one image sensor.

17. The crop measurement system of claim 1, wherein the controller is configured to receive a yield measurement of the harvested crop from a yield measurement sensor of the agricultural machine;
wherein the controller is configured to determine an adjusted yield value of the harvested crop based on the mass of the harvested crop stored in the tank; and
wherein the controller is configured to determine a calibration value for a yield calibration curve based on the yield measurement relative to the adjusted yield value.

18. The crop measurement system of claim 17, wherein the controller is configured to:
receive an additional yield measurement;
determine a yield output that is different from the additional yield measurement based on the additional yield measurement and the yield calibration curve; and
provide the yield output to a user display.

19. A method of measuring harvested crop for an agricultural machine, comprising:
receiving one or more signals from at least one weight sensor that is located in a tank of the agricultural machine, the tank being configured to store harvested crop and the one or more signals being indicative of the weight of a portion of the harvested crop stored in the tank;
receiving one or more signals from at least one image sensor indicative of the dimensions of the harvested crop stored in the tank and the location of the harvested crop stored in the tank; and
determining the mass of the harvested crop stored in the tank based on the one or more signals received from the at least one weight sensor and the one or more signals received from the at least one image sensor.

20. The method of claim 19, further comprising:
determining the mass of a remaining portion of harvested crop stored in the tank based on the dimensions of the harvested crop stored in the tank, the location of the harvested crop stored in the tank, the location of the at least one weight sensor, and the weight of the portion of the harvested crop measured by the at least one weight sensor; and
determining the mass of the harvested crop stored in the tank based on the mass of the portion of harvested crop stored in the tank and the mass of the remaining portion of harvested crop stored in the tank.
